(19) United States
(12) Patent Application Publication
(10) Pub. No.: US 2005/0257206 A1
(43) Pub. Date: Nov. 17, 2005

(54) Pair-update mechanism for update module

(76) Inventor: Krasimir P. Semerdzhiev, Sofia (BG)

Correspondence Address: Cory G. Claassen;BLAKELY, SOKOLOFF, TAYLOR & ZAFMAN LLP, Seventh Floor, 12400 Wilshire Boulevard, Los Angeles, CA, 90025, US

(21) Appl. No.: 10/846,300

(22) Filed: May 14, 2004

(51) Int. Cl. G06F 9/44

(52) U.S. Cl. 717/168

(57) ABSTRACT

A system and method for updating an update module. A pair-update module is executed to update software on a processing system. The pair-update module includes an installation updater and a bootstrap updater. The installation updater applies installation updates to installation files of the processing system, while the bootstrap updater applies bootstrap updates to the installation updater.

### TECHNICAL FIELD

This disclosure relates generally to software, and in particular but not exclusively, relates to updating an update module.

### BACKGROUND INFORMATION

FIG. 1 illustrates a known system for distributing software updates from a central database to distributed server/client nodes. Each node coupled to the central database includes an update module for retrieving updates from the central database and applying them to the node. A network administrator need only make available a patch, a new software product, or other software update on the central database and the individual update modules each retrieve the software update and apply it to their respective nodes.

However, current update modules have no ability to update themselves. Current update modules lack the ability to self-update because the operating system (“OS”) or virtual machine (“VM”) supporting the update module lock the update module files while the update module is executing. In other words, the update module cannot patch or update to its own files when those same files are currently open and executing in order to run the update module.

Thus, if a network administrator wishes to update the update module, the network administrator must manually apply the updates to the update module of each node. In large enterprise environments, hundreds or even thousands of nodes may be distributed throughout a local area network or even wide area network. Manually applying a patch or update to each node can be a time-consuming and costly undertaking.

### SUMMARY OF INVENTION

A system and method for updating an update module are described herein. In one embodiment, a pair-update module is executed on a processing system to update software of the processing system. The pair-update module includes an installation updater and a bootstrap updater. The installation updater applies installation updates to installation files of the processing system, while the bootstrap updater applies bootstrap updates to the installation updater.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates a known system for distributing software updates from a central database to a plurality of distributed nodes.

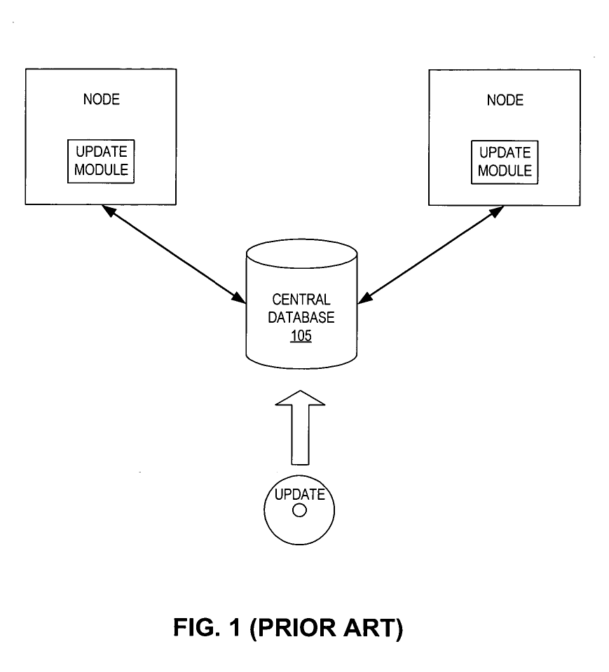

FIG. 2 is a block diagram illustrating a system including a pair-update module capable of updating itself, in accordance with an embodiment of the present invention.

FIG. 3 is a flow chart illustrating a process for updating installation files with an installation updater and updating the installation updater with a bootstrap updater, in accordance with an embodiment of the present invention.

FIG. 4 is a diagram illustrating a bootstrap script executable by a bootstrap updater to update an installation updater, in accordance with an embodiment of the present invention.

FIG. 5 is a block diagram illustrating a software environment of a processing node, in accordance with an embodiment of the present invention.

FIG. 6 is a block diagram illustrating an enterprise environment in which to implement a pair-update module to update server nodes, in accordance with an embodiment of the present invention.

FIG. 7 is a block diagram illustrating a demonstrative processing system for executing embodiments of the present invention.

### DETAILED DESCRIPTION

Embodiments of a system and method for updating a software update module are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

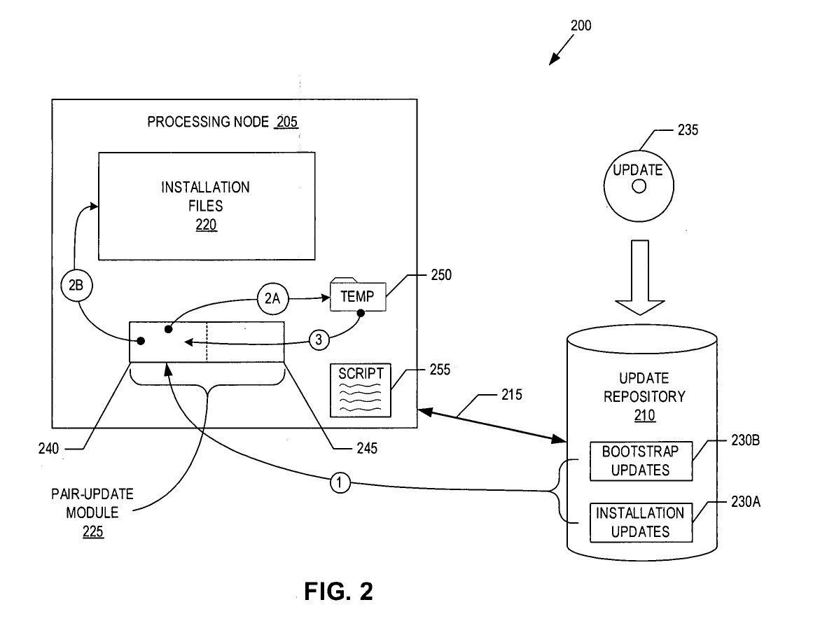

FIG. 2 is a block diagram illustrating a system 200 including a pair-update module capable of updating itself, in accordance with an embodiment of the present invention. The illustrated embodiment of system 200 includes a processing node 205 communicatively coupled to an update repository 210 via a network 215. The illustrated embodiment of processing node 205 includes installation files 220 and a pair-update module 225.

Updates may be placed in update repository 210 and made available to processing node 205. Update repository 210 may include a central database, a server, an archive, or other data storage medium. Network 215 is any type of communication channel including a local area network (“LAN”), a wide area network, (“WAN”), a wired or wireless connection, the Internet, a direct peripheral connection, or the like.

Update repository 210 may store installation updates 230A to be applied to installation files 220 and/or bootstrap updates 230B to be applied to pair-update module 225 itself (hereinafter installation updates 230A and bootstrap updates 230B are collectively referred to as updates 230). Updates 230 may be placed in update repository 210 using a plurality of known media or networks or future developed media or networks. For example, a network administrator may install the updates from a portable media 235, such as a compact disc (“CD”), into update repository 210. Alternatively, updates 230 may be created within update repository 210.

Pair-update module 225 is divided into two parts—an installation updater 240 and a bootstrap updater 245. Installation updater 240 applies installation updates 230A to installation files 220. Bootstrap updater 245 applies bootstrap updates to installation updater 240. Thus, embodiments of the present invention are capable of updating installation files 220 and pair-update module 225.

Installation files 220 include any files or data currently installed or residing on a machine-readable medium of processing node 205. For example, installation files 220 may include any of an operating system (“OS”), application files, data files, archive files, and the like. Similarly, pair-update module 225 may reside on any machine-readable medium communicatively coupled to processing node 205. In one embodiment, pair-update module 225 resides on a hard disk drive of processing node 205 and is transferred into system memory to be executed therefrom. In one embodiment, pair-update module 225 is transferred to processing node 205 from update repository 210 (or other database/server) over network 215.

The process explained below is described in terms of computer software and hardware. The techniques described may constitute machine-executable instructions embodied within a machine (e.g., computer) readable medium, that when executed by a machine will cause the machine to perform the operations described. Additionally, the processes may be embodied within hardware, such as an application specific integrated circuit (“ASIC”) or the like. The order in which some or all of the process blocks appear in each process should not be deemed limiting. Rather, one of ordinary skill in the art having the benefit of the present disclosure will understand that some of the process blocks may be executed in a variety of orders not illustrated.

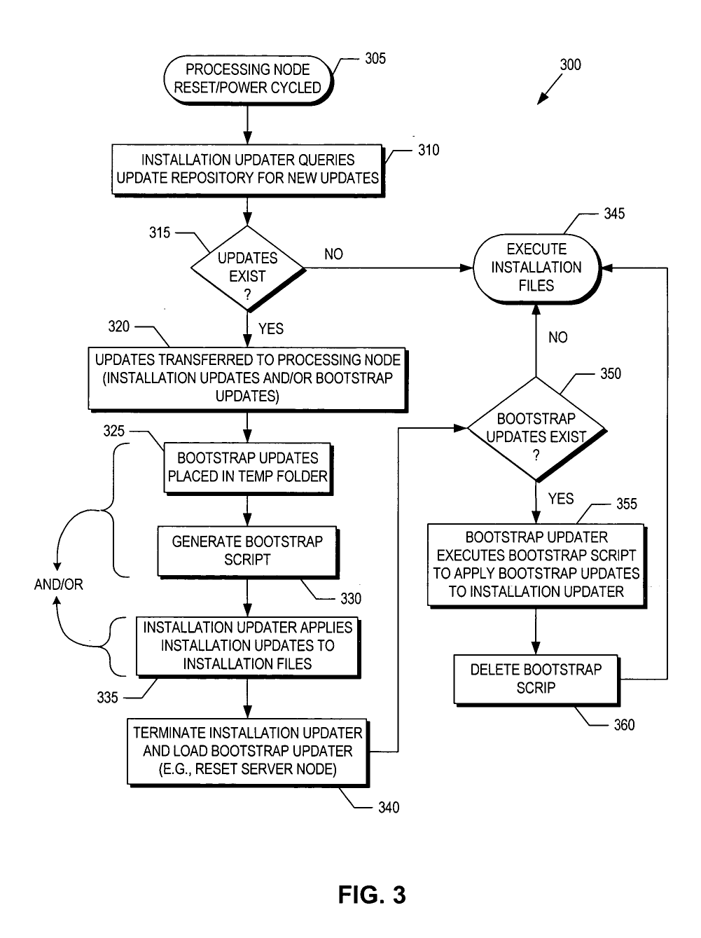

FIG. 3 is a flow chart illustrating a process 300 for updating installation files 220 and/or installation updater 240, in accordance with an embodiment of the present invention. In a processing block 305, processing node 205 is reset or otherwise power cycled. In a process block 310, installation updater 240 queries update repository 210 to determine whether new updates (e.g., updates 230) are available for processing node 205. Installation updater 240 may query update repository 210 each time processing node 205 is reset/power cycled, at set intervals, upon being instructed to by a user of processing node 205, upon being remotely instructed over network 215, or otherwise. In an alternative embodiment, update repository 210 or another server node coupled to network 215 may notify processing node 205 that updates 230 are available to be retrieved from update repository 210.

Updates 230 may include any type of files intended for processing node 205. For example, installation updates 230A may include patches to be applied to an OS, application, or firmware of processing node 205. Installation updates 230A may further include new applications, data, or archive files to be transferred to processing node 205. Likewise, bootstrap updates 230B may include a patch to be applied to installation updater 240 or even an entire new installation updater 240. Updates 230 may be compressed or uncompressed data, self-extracting executables (e.g., install wizards), instructions to delete expired files, instructions to rearrange existing files on processing node 205, or the like. Additionally, update repository 210 may contain a reference directory that is to be mirrored within processing node 205 as a target directory. In this embodiment, updates 230 represent differences between the reference directory residing within update repository 210 and the target directory residing on processing system 205. It should be appreciated that updates 230 represent any type of data or instructions intended to be applied to processing node 205.

If one or more of updates 230 are available (decision block 315), process 300 continues to a process block 320. In process block 320, the available updates are transferred from update repository 210 to processing node 205. If only one of updates 230 is available, then it may be transferred alone. If multiple updates 230 are available, then all of them may be transferred together at once. Accordingly, in one embodiment, if both installation updates 230A and bootstrap updates 230B are available, installation updater 240 may retrieve both updates together. As illustrated in FIG. 2, updates 230 are retrieved from update repository 210 along task arrow 1. It should be appreciated that each task arrow may represent multiple transactions to accomplish the described task.

In a process block 325, bootstrap updates 230B are placed into a temporary folder 250 (task arrow 2A). In a process block 330, a bootstrap script 255 is generated and saved to a known location for future reference. Bootstrap script 255 is generated in response to bootstrap updates 230B. Bootstrap script 255 contains instructions executable by bootstrap updater 245 to apply bootstrap updates 230B to installation updater 240. In one embodiment, installation updater 240 places bootstrap updates 230B into temporary folder 250 and generates bootstrap script 255.

In a process block 335, installation updater 240 applies installation updates 230A to installation files 220 (task arrow 2B). In one embodiment, applying installation updates 230A to installation files 220 includes overwriting old files with new files, adding new files to installation files 220, deleting some or all of pre-existing installation files 220, and/or rearranging installation files 220.

It should be appreciated that if both installation updates 230A and bootstrap updates 230B are available, then process blocks 325, 330, and 335 may all be executed. However, if only installation updates 230A are available, then process blocks 325 and 330 may be skipped. Correspondingly, if only bootstrap updates 230B are available, then process block 335 may be skipped.

After bootstrap updates 230B have been temporarily stored and/or installation updates 230A applied to installation files 220, installation updater 240 is terminated and bootstrap updater 245 loaded for execution (process block 340). Installation updater 240 is terminated to grant bootstrap updater 245 access to the files of installation updater 240, if bootstrap updates 230B were available. The files of installation updater 240 should be released by the OS or virtual machine (“VM”), on which installation updater 240 may be executing, prior to updating them. This policy of releasing installation updater 240 prior to applying bootstrap updates 230B may be required by the underlying OS or VM and is wise practice to prevent the occurrence of runtime errors and conflicts. In one embodiment, processing node 205 is reset after terminating installation updater 240 and before loading bootstrap updater 245.

After loading bootstrap updater 245, if bootstrap updates 230B are buffered in temporary file 250 (decision block 350), process 300 continues to a process block 355. In one embodiment, bootstrap updater 245 determines whether bootstrap updates 230B are buffered by determining whether bootstrap script 255 has been generated. In one embodiment, bootstrap updater 245 queries a known location where bootstrap script 255 is always placed by installation updater 240. In one embodiment, bootstrap updater 245 determines whether bootstrap updates 230B are buffered with reference to a status flag set by installation updater 240.

In process block 355, bootstrap updater 245 applies bootstrap updates 230B, currently stored within temporary file 250, to installation updater 240 (task arrow 3). In one embodiment, bootstrap updater 245 determines how to apply bootstrap updates 230B by executing bootstrap script 255. In one embodiment, once all bootstrap updates 230B are applied to installation updater 240, bootstrap updater 245 deletes bootstrap script 255. In the embodiment where a status flag signals to bootstrap updater 245 that bootstrap updates 230B are buffered, bootstrap updater 245 may simply clear the status flag in process block 360. Subsequently, installation files 220 (e.g., OS) are executed in a process block 345. In other embodiments (not illustrated), bootstrap updater 245 is an application executed on and supported by an OS and/or VM. As such, installation files 220 may be loaded prior to or at the same time as bootstrap updater 245.

Returning to decision block 350, if bootstrap updates 230B do not exist, then process 300 continues to a process block 345 without updating installation updater 240. Similarly, returning to decision block 315, if update repository 210 does not contain new updates 230, then process 300 continues directly to process block 345 to execute installation files 220 without updating installation updater 225 or installation files 220.

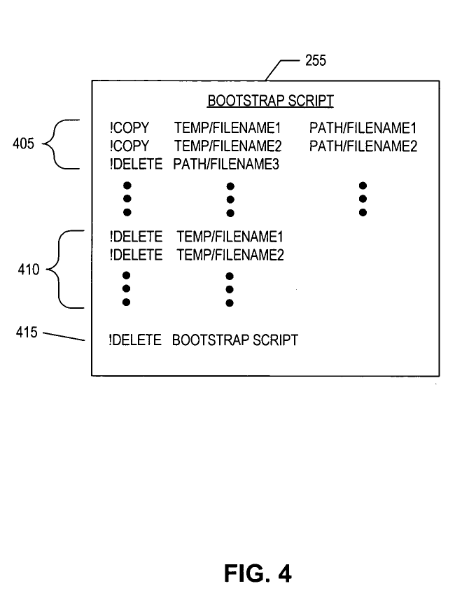

FIG. 4 illustrates a one possible embodiment of a bootstrap script 255, in accordance with an embodiment of the present invention. The illustrated embodiment of bootstrap script 255 includes a number of simple commands, such as copy (or move) and delete, to be implemented by bootstrap updater 245.

In one embodiment, bootstrap script 255 includes a first set of commands 405 for updating installation updater 240. For example, the first of commands 405 instructs bootstrap updater 245 to copy FILENAME1 located in temporary folder 250 to a location PATH/. In this case, PATH/ may be a directory storing system files for installation updater 240. The last of commands 405 instructs bootstrap updater 245 to delete FILENAME3 currently residing within directory PATH/, which perhaps is no longer useful and designated for deletion as part of the update of installation updater 240.

In one embodiment, bootstrap script 255 may further include commands 410 to delete the contents of temporary folder 250 after bootstrap updates 230B have been applied to installation updater 240. Finally, bootstrap script 255 may further include command(s) 415 for deleting bootstrap script 255 itself. Alternatively, command 415 may instruct bootstrap updater 245 to clear the status flag set by installation updater 240 to indicate that bootstrap updates 230B have been applied.

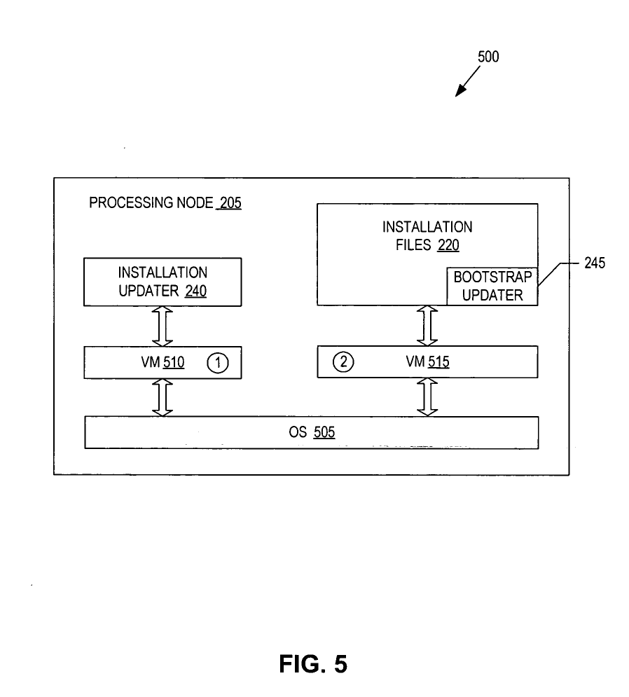

FIG. 5 is a block diagram illustrating a software environment 500 of processing node 205, in accordance with an embodiment of the present invention. The illustrated embodiment of software environment 500 includes an OS 505, virtual machines (“VMs”) 510 and 515, installation files 220, installation updater 240, and bootstrap updater 245. It should be appreciated that FIG. 5 illustrates only one possible software environment for implementing the pair-update mechanism described above. In one embodiment, VMs 510 and 515 are Java Virtual Machines (“JVMs”).

In the illustrated embodiment, bootstrap updater 245 resides within or is part of installation files 220. Thus, in one embodiment, installation updater 240 and bootstrap updater 245 are distinct entities (e.g., different objects in an object oriented world), which together provide the pair-update mechanism to update all software aspects of processing node 205—both installation files 220 and pair-update module 225. Accordingly, together installation updater 240 and bootstrap updater 245 represent pair update module 225.

As illustrated by the circled 1, VM 510 may first execute to support installation updater 240 while installation files 220 are updated with installation updates 230A. In the illustrated embodiment, it should be appreciated that since bootstrap updater 245 is a part of installation files 220, bootstrap updater 245 may be patched or otherwise updated at the same time as installation files 220 by installation updater 240. Once installation updater 240 has completed applying installation updates 230A, VM 510 and installation updater 240 are terminated. As discussed above, terminating installation updater 240 releases its files allowing access to these files for patching or updating.

As illustrated by the circled 2, VM 515 may be executed subsequent to VM 510 to support installation files 220 and bootstrap updater 245. In turn bootstrap updater 245 applies bootstrap updates 230B to installation updater 240. In this manner, embodiments of the present invention are capable of updating 100% of software environment 500, including pair-update module 225. Thus, the updater is updated.

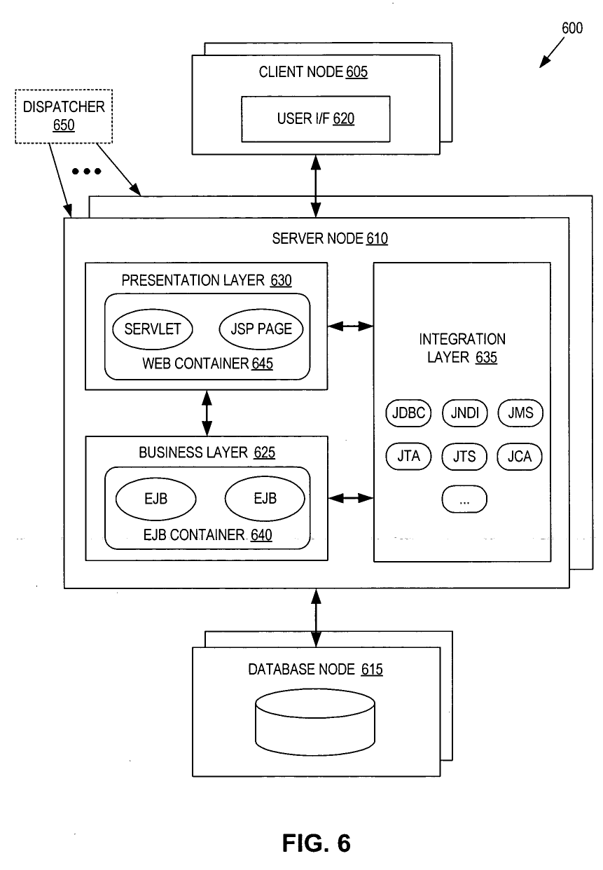

FIG. 6 is a block diagram illustrating an enterprise environment 600 in which to implement embodiments of pair-update module 225, in accordance with the techniques described herein. Enterprise environment 600 is a multi-tier architecture implemented using a variety of different technologies at each sub-layer, including those based on the Java 2 Platform, Enterprise Edition™ (“J2EE”) standard (e.g., J2EE Specification, Version 1.4), the Microsoft .NET standard, the Advanced Business Application Programming (“ABAP”) standard developed by SAP AG, and the like.

Enterprise environment 600 includes one or more client nodes 605 communicatively coupled to one or more server nodes 610, which are in turn communicatively coupled to one or more database nodes 615. A user interface 620 provides a graphical user interface (“GUI”) to enable users of client nodes 605 to interact with database nodes 615 (e.g., submit queries, input data, etc.) through server nodes 610. Embodiments of user interface 620 include proprietary applications and standard applications, such a web browser (e.g., Internet Explorer or Netscape Navigator).

Server nodes 610 each include a business layer 625, a presentation layer 630, and an integration layer 635, which together form subcomponents of an Application Server (e.g., WebAS 6.40 by SAP AG). Business layer 625 provides the business logic of the Application Server, enabling complex business processes to be implemented. In J2EE embodiments, business layer 625 may include one or more Enterprise JavaBean (“EJB”) containers 640 each including one or more EJBs. The EJBs are Java based software modules that contain the actual business logic, while EJB container 640 encapsulates the EJBs in a Java based runtime environment that provides a host of common interfaces and services to the EJBs.

Presentation layer 630 describes the specific manner in which the results of business layer 625 are formatted for display on the user interface 620. The results may be formatted with aid of a web container 645 that supports both Servlets and JavaServer Pages (“JSPs”). The servlets provide server-side processing to generate the GUI and the JSPs are extensions of the Java servlet technology for providing dynamic content within the GUI.

Integration layer 635 ensures access to business functionalities from external resources. This is done using various interfaces, connectors (middleware), communication protocols, and support for general data exchange formats (e.g., extensible markup language). For example, integration layer 635 may contain support for the following services: Java Database Connectivity (“JDBC”) Application Programming Interface (“API”), the Java Naming and Directory Interface (“JNDI”), the Java Messaging Service (“JMS”), the Java Transaction Service (“JTS”), the Java Transaction API (“JTA”), the J2EE Connector Architecture (“JCA”), and the like.

Multiple server nodes 610 may be grouped together to form a cluster of server nodes 610. A copy of the Application Server may reside on each server node 610 providing a sort of distributed environment and a redundant set of application logic and associated data. In one embodiment, a dispatcher 650 implements a load-balancing mechanism to distribute service requests from client nodes 605 among server nodes 610 within the cluster. For example, dispatcher 650 may implement a round-robin load-balancing mechanism. In one embodiment, dispatcher 650 is one of server nodes 610 having the task of dispatching service requests among server nodes 610 of the cluster.

The service requests are processed by server nodes 610 and subsequently provided to database nodes 615. Database nodes 615 offer up the requested data to server nodes 610, which in turn process and format the results for display on user interfaces 620 of client nodes 605.

Embodiments of the present invention may be provided for updating both installation files and the pair-update module itself on each of client nodes 605, server nodes 610, and database nodes 615. In particular, pair-update module 225 may be provided with each server node 610 to retrieve and apply updates from database nodes 615, as described above. In one embodiment, business layer 625, presentation layer 630, and/or integration layer 635 represent installation files 220.

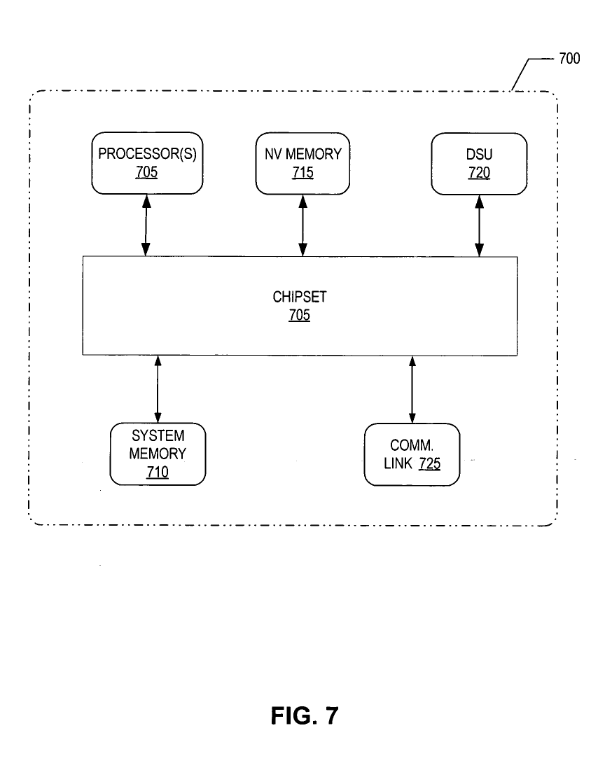

FIG. 7 is a block diagram illustrating a processing system 700 for implementing processing node 205, in accordance with an embodiment of the present invention. The illustrated embodiment of processing system 700 includes one or more processors (or central processing units) 705, system memory 710, nonvolatile (“NV”) memory 715, a data storage unit (“DSU”) 720, a communication interface 725, and a chipset 730. The illustrated processing system 700 may represent any computing system including a client computer, a desktop computer, a notebook computer, a workstation, a handheld computer, a server, a blade server, a database, and the like.

The elements of processing system 700 are interconnected as follows. Processor(s) 705 is communicatively coupled to system memory 710, NV memory 715, DSU 720, and communication interface 725, via chipset 730 to send and to receive instructions or data thereto/therefrom. In one embodiment, NV memory 715 is a flash memory device. In other embodiments, NV memory 715 includes any one of read only memory (“ROM”), programmable ROM, erasable programmable ROM, electrically erasable programmable ROM, or the like. In one embodiment, system memory 710 includes random access memory (“RAM”). DSU 720 represents any storage device for software data, applications, and/or operating systems, but will most typically be a nonvolatile storage device. DSU 720 may optionally include one or more of an integrated drive electronic (“IDE”) hard disk, an enhanced IDE (“EIDE”) hard disk, a redundant array of independent disks (“RAID”), a small computer system interface (“SCSI”) hard disk, and the like. Although DSU 726 is illustrated as internal to processing system 700, DSU 720 may be externally coupled to processing system 700. Communication interface 725 may couple processing system 700 to a network (e.g., network 215) such that processing system 700 may communicate over the network with one or more other machines (e.g., update repository 210). Communication interface 725 may include a modem, an Ethernet card, Universal Serial Bus (“USB”) port, a wireless network interface card, or the like.

It should be appreciated that various other elements of processing system 700 have been excluded from FIG. 7 and this discussion for the purposes of clarity. For example, processing system 700 may further include a graphics card, additional DSUs, other persistent data storage devices (e.g., tape drive), and the like. Chipset 730 may also include a system bus and various other data buses for interconnecting subcomponents, such as a memory controller hub and an input/output (“I/O”) controller hub, as well as, include data buses (e.g., peripheral component interconnect bus) for connecting peripheral devices to chipset 730. Correspondingly, processing system 700 may operate without one or more of the elements illustrated.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
executing a pair-update module of a processing system to update software of the processing system, the pair-update module including an installation updater and a bootstrap updater, the installation updater to apply installation updates to installation files of the processing system and the bootstrap updater to apply bootstrap updates to the installation updater; and
applying the bootstrap updates to the installation updater.

2. The method of claim 1, further comprising:
querying an update repository to determine whether the bootstrap updates are available for the processing system; and
if the bootstrap updates are available, then retrieving the bootstrap updates from the update repository.

3. The method of claim 2, further comprising generating a bootstrap script to instruct the bootstrap updater how to apply the bootstrap updates to the installation updater.

4. The method of claim 3, wherein applying the bootstrap updates to the installation updater comprises:
terminating the installation updater after retrieving the bootstrap updates to release the installation updater for applying the bootstrap updates to the installation updater;
loading the bootstrap updater; and
executing the bootstrap script to apply the bootstrap updates to the installation updater.

5. The method of claim 1, further comprising:
querying the update repository to determine whether the installation updates and the bootstrap updates are available for the processing system; and
if the installation updates and the bootstrap updates are available, then retrieving the installation updates and the bootstrap updates from the update repository.

6. The method of claim 5, further comprising applying the installation updates to the installation files, and wherein applying the bootstrap updates to the installation updater comprises applying the bootstrap updates to the installation updater after the installation updates have been applied to the installation files and the installation updater terminated.

7. The method of claim 1, wherein the processing system comprises a server node of an enterprise system and wherein the installation files comprise a Web Application Server.

8. The method of claim 7, wherein the Web Application Server is based on one of a .NET framework and a Java Enterprise framework.

9. A machine-accessible medium that provides instructions that, if executed by a machine, will cause the machine to perform operations comprising:
executing a pair-update module including an installation updater and a bootstrap updater to update software of the machine;
updating installation files of the machine by the installation updater; and
updating the installation updater of the machine by the bootstrap updater.

10. The machine-accessible medium of claim 9, further providing instructions that, if executed by the machine, will cause the machine to perform further operations, comprising:
querying an update repository to determine whether at least one of installation updates and bootstrap updates are available for the machine; and
if at least one of the installation updates and the bootstrap updates are available, then retrieving the at least one of the installation updates and the bootstrap updates from the update repository.

11. The machine-accessible medium of claim 10, wherein updating the installation files comprises applying the installation updates to the installation files and wherein updating the installation updater comprises applying the bootstrap updates to the installation updater.

12. The machine-accessible medium of claim 11, further providing instructions that, if executed by the machine, will cause the machine to perform further operations, comprising:
generating a bootstrap script to instruct the bootstrap updater to apply the bootstrap updates to the installation updater.

13. The machine-accessible medium of claim 12, wherein applying the bootstrap updates to the installation updater comprises:
terminating the installation updater after retrieving the at least one of the installation updates and the bootstrap updates to release the installation updater for applying the bootstrap updates to the installation updater;
loading the bootstrap updater; and
executing the bootstrap script to apply the bootstrap updates to the installation updater.

14. The machine-accessible medium of claim 9, wherein the machine comprises a server node of an enterprise system and wherein the installation files comprise a Web Application Server.

15. The machine-accessible medium of claim 14, wherein the Web Application Server is based on one of a .NET framework and a Java Enterprise framework.

16. A system, comprising:
a database having stored therein a bootstrap update; and
a server node communicatively coupled to the database, the server node comprising a processor and logic executable by the processor to:
execute a pair-update module to update software of the server node, the pair-update module including an installation updater and a bootstrap updater, the installation updater to update installation files of the server node and the bootstrap updater to update the installation updater;
retrieve bootstrap updates from the database; and
update the installation updater with the bootstrap updates.

17. The system of claim 16, wherein the database further having stored therein installation updates, and further comprising logic executable by the processor to:
retrieve the installation updates from the database; and
update the installation files with the installation updates.

18. The system of claim 17, wherein the server node further comprises logic executable by the processor to:
query the database to determine whether the installation updates and the bootstrap updates are available prior to retrieving the bootstrap updates and the installation updates.

19. The system of claim 18, wherein the server node further comprises logic executable by the processor to:
generate a bootstrap script to instruct the bootstrap updater to apply the bootstrap updates to the installation updater.

20. The system of claim 19, wherein the logic to apply the bootstrap updates to the installation updater comprises logic executable by the processor to:
terminate the installation updater after transferring the bootstrap updates and the installation updates to release the installation updater to apply the bootstrap updates to the installation updater;
load the bootstrap updater; and
execute the bootstrap script to apply the bootstrap updates to the installation updater.

21. The system of claim 16, wherein the server node comprises a Web Application Server node of an enterprise system.

22. The system of claim 21, wherein the Web Application Server node is based on one of a .NET framework and a Java Enterprise framework.

23. A system, comprising:
means for retrieving installation updates and bootstrap updates from an update repository;
installation updater means for updating installation files of a server node with the installation updates; and
bootstrap updater means for updating the installation updater means.

24. The system of claim 23, further comprising:
means for querying the update repository to determine whether the installation updates and the bootstrap updates are available.

25. The system of claim 24, further comprising:
means for generating a bootstrap script to instruct the bootstrap updater means how to apply the bootstrap updates to the installation updater means after the installation updater means has been terminated.

26. The system of claim 24 wherein the installation updater means also comprises the means for retrieving and the means for querying.

27. The system of claim 25 wherein the installation updater means also comprises the means for generating.
